(19) United States
(12) Patent Application Publication
(10) Pub. No.: US 2015/0310100 A1
(43) Pub. Date: Oct. 29, 2015

(54) PRESENTING USER-GENERATED CONTENT IN SEARCH RESULTS

(71) Applicant: Google Inc., Mountain View, CA (US)

(72) Inventors: Adam D. Bursey, San Jose, CA (US); David Yen, Plano, TX (US); Matthew E. Kulick, San Francisco, CA (US); Amay Nitin Champaneria, San Francisco, CA (US)

(73) Assignee: Google Inc., Mountain View, CA (US)

(21) Appl. No.: 13/737,073

(22) Filed: Jan. 9, 2013

Related U.S. Application Data
(60) Provisional application No. 61/584,657, filed on Jan. 9, 2012.

(51) Int. Cl. G06F 17/30

(52) U.S. Cl. CPC G06F 17/30864

(57) ABSTRACT

Techniques for presenting using-generated content in search results may include the following operations: receiving a search query from a computing device of a user; obtaining search results responsive to the search query, where the search results correspond to digital content stored in one or more computer-readable storage media, and where at least some of the search results correspond to content that is user-generated; generating data for the search results, where the data is for displaying at least some information relating to the user-generated content along with search results other than the user-generated content; and transmitting the data to the computing device for generating a display of the search results in accordance with the data.

### CROSS-REFERENCE TO RELATED APPLICATION

Priority is hereby claimed to U.S. Provisional Application No. 61/584,657, which was filed on Jan. 9, 2012. The contents of U.S. Provisional Application No. 61/584,657 are hereby incorporated by reference into this disclosure.

### BACKGROUND

This disclosure relates generally to presenting user-generated content in search results.

Search engines provide information about resources (e.g., Web pages, images, text documents, and multimedia content) that are responsive to users' queries. A search result may include, for example, a Uniform Resource Locator (URL) and a snippet of information for a resource responsive to a query. Search results may be ranked according to scores assigned to the search results by a scoring function. The scoring function generates the scores for the search results according to various signals, for example, where and how often query terms appear in the search results and how common the query terms are in the search results.

A large number of search results may be returned for a given query. Consequently, it may be difficult for a user to choose a search result that is most relevant to the user or that provides advice that the searching user is comfortable relying upon. A user may give more weight to search results that are associated with reviews, opinions, or other content associated with the user's social graph (e.g., contacts of the user) and/or other users.

### SUMMARY

Techniques for presenting using-generated content in search results may include the following operations: receiving a search query from a computing device of a user; obtaining search results responsive to the search query, where the search results correspond to digital content stored in one or more computer-readable storage media, and where at least some of the search results correspond to content that is user-generated; generating data for the search results, where the data is for displaying at least some information relating to the user-generated content along with search results other than the user-generated content; and transmitting the data to the computing device for generating a display of the search results in accordance with the data. The foregoing techniques may include one or more of the following features, either alone or in combination.

The user-generated content may be generated by either the user or by one or more other parties to which the user has a social connection. The user-generated content may include content obtained from an account of the user, which content was generated by, received by, or sent by, the user. Permission may be received from the user to search the user-generated content.

The operations for obtaining the search results may include identifying one or more social connections of the user; and searching indexed content corresponding to the one or more social connections to identify indexed content relevant to the search query.

The user-generated content may be first content, and the operations may include identifying second content that is associated with the first content; and including the second content in the search results. The data may be for displaying the second content in association with the first content. The second content may be part of the user-generated content. The second content may be responsive to the user-generated content or the user-generated content is responsive to the second content.

The search results may include a type of content, and the user-generated content may contain the type of content. The data may be for displaying the type of content from the user-generated content among the type of content from the search results and apart from other types of content in the search results.

The at least some information relating to the user-generated content may include an excerpt from the user-generated content and/or a summary of information about the user-generated content. The summary of information may include at least one of: an identity of a social connection associated with the user-generated content, a number of instances of the user-generated content, a number of instances of user-generated content per social connection, a source of the user-generated content, and an excerpt from the user-generated content.

The user-generated content may include a digital image, and the operations may include: determining that the user-generated content is without text associated with the digital image; and deciding that the digital image is to be displayed within an image search results portion of the search results in response to determining that the user-generated content is without text associated with the digital image.

The user-generated content may include at least one of: an electronic message, text from a chat session, a post to a social networking service, a digital image, video, audio, and a blog post. The search results other than the user-generated content may include search results having relevance to the search query that is independent of the social connection.

The techniques for presenting using-generated content in search results may include determining whether the search query identifies a type of user-generated content. Display of the search results may be based on whether the search query identifies a type of user-generated content. In a case that the search query identifies the type of user-generated content, the data may indicate to display search results containing user-generated content at a top of a first page of search results. In a case that the search query does not identify the type of user-generated content, the data may indicate to display an option to view search results containing user-generated content proximate to the search results other than the user-generated content. In a case that the search query does not identify the type of user-generated content, and the user has indicated to display at least some of the user-generated content, the data may indicate to display search results containing at least some of the user-generated content proximate to the search results other than the user-generated content.

Advantages of the foregoing techniques may include, but are not limited to, providing a searcher with additional, possibly relevant, content from sources that the searcher may trust, e.g., due to a social connection to the searcher.

The systems and techniques described herein, or portions thereof, may be implemented as a computer program product that includes instructions that are stored on one or more non-transitory machine-readable storage media, and that are executable on one or more processing devices. The systems and techniques described herein, or portions thereof, may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a block diagram showing an example of a network environment on which the process described herein may be implemented.

FIG. 2 is a block diagram of an example part of the network environment of FIG. 1.

FIG. 3 a conceptual view of an example of a social graph.

FIG. 4 is a flow diagram of an example process for retrieving and presenting search results.

FIG. 5 shows example components of a search system.

FIGS. 6 to 17 show examples of Web pages containing user-generated content in search results.

Like reference symbols in the various drawings indicate like elements.

### DETAILED DESCRIPTION

Described herein are techniques for retrieving user-generated content and for displaying the user-generated content as part of search results. By way of example, user-generated content may include, but is not limited to, content in electronic messages, chat sessions, posts to social networking services, posts to sharing services (e.g., photo sharing services) and/or posts to a blogging service.

User-generated content may include content that is access controlled. Access controlled content may be associated with privacy settings configured so that select users are able to access such content. Example access-controlled content may include content provided in electronic messages, chat sessions and/or posts to social networking services. For example, an electronic messaging service may have privacy settings such that content of electronic messages is accessible to the author of the electronic messages and to recipients of the electronic message, but not to others. In another example, a chat session may have privacy settings such that content of the chat session is accessible to participants in the chat session, but not to others. In another example, a post to a social networking service may have privacy settings such that content of the post is accessible to the author of the post and to those whom the user has granted access, but not to others.

In cases where user-generated content is access controlled, a search engine may obtain access control information (e.g., a password and username), and permission, from the account or content owner(s), to access the user-generated content. In addition, privacy features may provide a user with one or more option(s) to allow their content to be included in search results or to prevent their content from being included in search results.

User-generated content may be identified using a social graph of the searcher. As explained below, a social graph is a construct that represents social connections between two parties (e.g., people, entities, content, etc.), which may, or may not, be on the same social network. For example, the searcher's social graph may contain connections to various parties who regularly send electronic messages to the searcher. Content from these electronic messages may be part of the user-generated content that is displayed along with other search results.

In this regard, the search results may be obtained by a search engine, e.g., in response to a search query provided by a user. The search results may include content that is publicly available, and may also include the user-generated content described herein, among other content. In some implementations, and as explained below, the user-generated content may be displayed in different ways in a search results Web page. For example, content from an electronic message may be displayed, links to electronic messages may be displayed, information about the sender of the electronic message may be displayed, and so forth. Where information about users is displayed, permission may first be obtained from those users. In some implementations, selection processes may be executed to determine the display format. In other implementations, a user may set display preferences, e.g., in their profile, on a settings page, at login, during search, and so forth.

The techniques described herein may be implemented in an appropriate network environment, with appropriate devices and computing equipment. An example of such a network system is provided below.

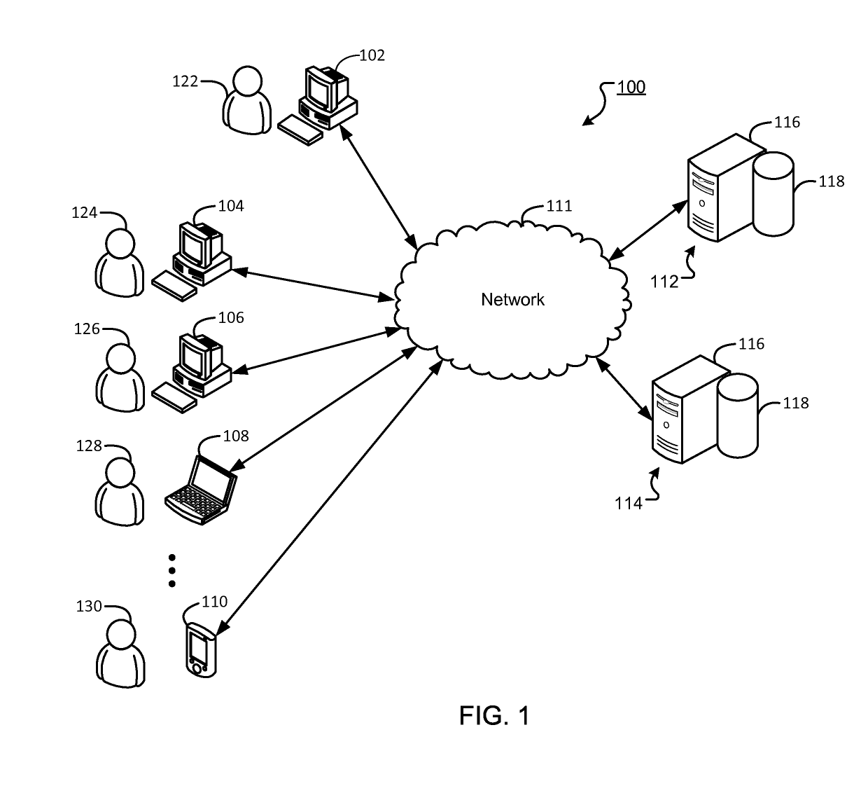

FIG. 1 is a block diagram showing an example of a network environment on which the techniques described herein may be implemented. FIG. 1 shows example network environment 100. Network environment 100 includes computing devices 102, 104, 106, 108, 110 that are configured to communicate with a first server system 112 and/or a second server system 114 over a network 111. Computing devices 102, 104, 106, 108, 110 have respective users 122, 124, 126, 128, 130 associated therewith. The first and second server systems 112, 114 each includes a computing device 116 and a machine-readable repository, or database 118. Example environment 100 may include many thousands of Web sites, computing devices and servers, which are not shown.

Network 111 may include a large computer network, examples of which include a local area network (LAN), wide area network (WAN), the Internet, a cellular network, or a combination thereof connecting a number of mobile computing devices, fixed computing devices, and server systems. The network(s) included in network 111 may provide for communications under various modes or protocols, examples of which include Transmission Control Protocol/Internet Protocol (TCP/IP), Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, e.g., using a BLUETOOTH, WiFi, or other such transceiver system.

Computing devices 102 to 110 enable respective users 122 to 130 to access and to view documents, e.g., Web pages included in Web sites. For example, user 122 of computing device 102 may view a Web page using a Web browser. The Web page may be provided to computing device(s) 102 to 110 by server system 112, server system 114 or another server system (not shown).

In example environment 100, computing devices 102, 104, 106 are illustrated as desktop-type computing devices, computing device 108 is illustrated as a laptop-type computing device 108, and computing device 110 is illustrated as a mobile computing device. It is noted, however, that computing devices 102 to 110 may include, e.g., a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an electronic messaging device, a game console, or a combination of two or more of these data processing devices or other appropriate data processing devices. In some implementations, a computing device may be included as part of a motor vehicle (e.g., an automobile, an emergency vehicle (e.g., fire truck, ambulance), a bus).

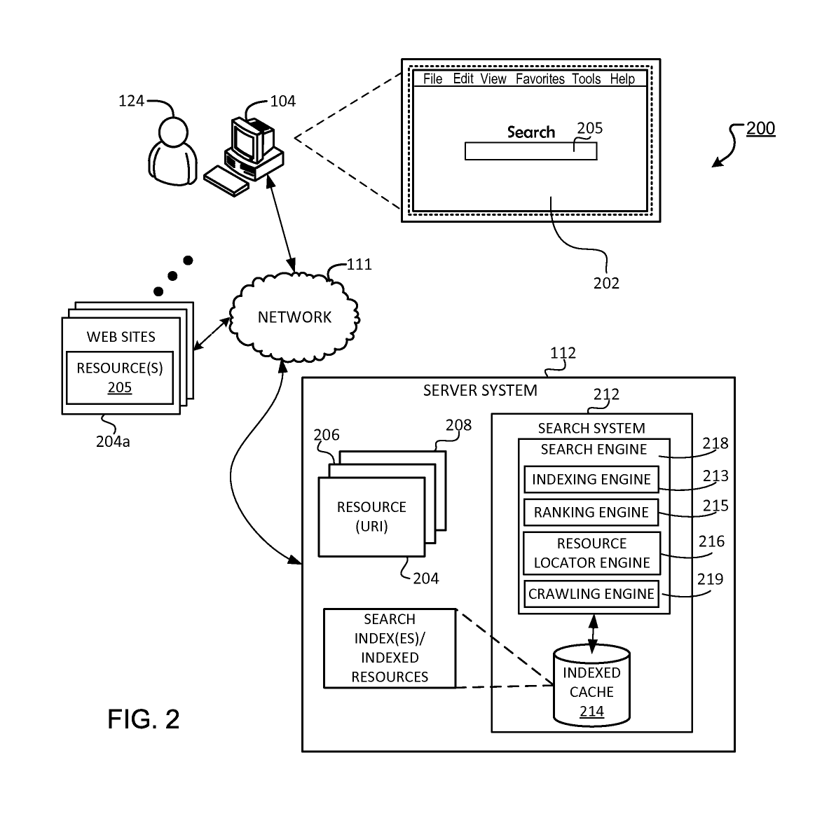

FIG. 2 is a block diagram of an example part of the network environment of FIG. 1. Specifically, FIG. 2 shows portion 200 of example network environment 100. In this example implementation, server system 112 stores a plurality of resources 204, 206, 208. A resource has an associated resource identifier (Resource ID). For example, resources 204, 206, 208 may correspond to different Web pages of the same Web site, or may correspond to Web pages of different Web sites. As explained below, in this example operation, computing device 104 communicates with server system 112 to display a home Web page (“home page”) 202 of a search engine Web site.

To view a Web page, user 124 may input or select a Resource ID using a browser that is executed on computing device 104. The Resource ID may include, for example, a uniform resource indicator (URI) or a uniform resource locator (URL). A request including the Resource ID is transmitted from computing device 104 to server system 112 over network 111. In response, the server system identifies the requested resource based on the Resource ID, and transmits the resource to computing device 104 over network 111. For example, the resource may be home page 202, through which a user may access search system 212. The home page may include a field 205 for inputting a search query that is transmitted to the search system. The search query may include, e.g., one or more terms (e.g., text), images, audio, video, or other content. In response, the search system performs a search of an indexed cache containing one or more search indexes, and returns a search results list to a user. The search results list may include, e.g., links to content that is deemed relevant to the search terms.

Search system 212 may be implemented, e.g., on server system 112 as shown or on other appropriate hardware. Search system 212 includes a search engine 218 and one or more search indexes. Search system 212 identifies resources 205 (e.g., Web pages, images, news articles, user-generated content, social information, or other public or private resources) provided by content publishers on Web sites 204a or elsewhere. Search system 212 include a crawling engine 219 to crawl those resources, and an indexing engine 213 to index those resources in one or more search indexes (referred to collectively as a “search index”) stored in memory, e.g., in indexed cache 214. Search engine 218 also includes a resource locator engine 216 for identifying resources within the search index that are responsive to, and that may be relevant to, the query (for example, by implementing a query text matching routine). A ranking engine 215 ranks resources deemed relevant to the search query for output to computing device 104.

Social graph information may be included in a same search index as other resources or in a separate search index (not shown). As described in more detail below, social graph information may include, e.g., comments, endorsements, connections, affinities, and so forth related to indexed content and to a user's social graph. A separate search may be performed for general search results responsive to a query, as well as particular search results that identify resources associated with the user's social graph (e.g., endorsed Web content).

In some implementations, information associated with the user's social graph may be indexed by generating and incorporating suitable data structures, e.g., social restricts, in an existing search index. In some examples, the indexing engine may generate social restricts by mapping identified information to corresponding Web resources referenced in a search index and determining the social connection between the Web resources and the user. For example, the system may access a relationship lookup table that includes relationship data describing a user's social graph to determine such social connections. In some examples, social restricts may be provided in the form of an information tag or other data associated with a referenced Web resource included in the search index.

User-generated content may be included in a same index as other resources or in a separate index (not shown). In this regard, with appropriate permission from the content owner, crawling engine 219 may crawl user-generated content (of both the searcher and others, e.g., members of the searcher's social graph), and indexing engine 213 may incorporate that content into an appropriate search index. Resource locator engine 216 may identify that user-generated content based, e.g., on a relevance score of the user-generated content to a search query and based, e.g., on other information, including, e.g., the social connection of the searcher to the content itself or to an author of the content. In this regard, the existence or non-existence of a social connection to the content or author may affect the relevance score. In this context, an author is not limited to one who created the content, but may include, e.g., a party that interacted with the content, shared the content, endorsed the content, posted the content, and so forth.

In response to a search query, search engine 218 may access indexed cache 214 to identify resources 205 that are relevant to the search query. Resource locator engine 216 identifies resources 205 in the form of search results for return to a requesting device in search results pages. A search result may include data generated by search system 212 that identifies a resource 205, and that includes a link to the corresponding resource, along with images, video, or other appropriate content. An example search result may include a Web page title, a snippet of text or a portion of an image extracted from the Web page, and the URL of the Web page. In some cases, the search results may also include social information. For example, included with some of the search results may be comments, endorsements, or other information obtained about the search results from a user's social graph. The social information may also be used to affect retrieval, ranking, and display of the search results, as described below. The search results may also include user-generated content displayed alone or in association with relevant social information (e.g., a link to a content author's profile).

As noted above, a social graph is a way to represent, graphically, social connections between two parties that may, or may not, be on the same social network, and to represent connections between parties and content. A party may be an individual or an entity, e.g., a company, organization, country, or the like. Types of connections in social graphs may include, but are not limited to, other users to which a user is in direct contact (e.g., user messaging or chat contact, direct contacts on social sites) and users to which the user is in indirect contact (e.g., contacts of contacts, connections of users that have a direct connection to the user). In some examples, a direct connection may be unilateral or bilateral. In some implementations, a social graph includes content generated by individuals (e.g., blog posts, reviews) as connections to the user. The social graph may include connections within a single network or across multiple networks.

Distinct social graphs may be generated for different types of connections. For example, a user may be connected with chat contacts in one social graph, electronic message contacts in a second social graph, and connections from a particular social network in a third social graph. A social graph may include edges to additional parties at greater degrees of separation from the user. For example, an electronic message contact may have its own electronic message contacts to others adding a degree of separation from the user (e.g., user→electronic message contact→contact of electronic message contact). These contacts may, in turn, may have additional contacts at another degree of separation from the user. Similarly, a party's connection to someone in a particular social network may be used to identify additional connections based on that person's connections. Distinct social graphs may include edges connecting one or more social graphs to one or more other social graphs. Thus, a social graph may include a single social graph or multiple interconnected social graphs.

Users may designate content as endorsed, share or comment on content, quote URLs, or otherwise indicate an interest or liking of content, examples of which include, but are not limited to, a particular resource, Web page, or search result. For example, an application, widget, or scripting may be provided in search results pages, Web pages, or within a Web browser application that allows a user to indicate liking, sharing, or other evaluation of an associated resource or search result. The user may mark the particular resource, Web site, or search results to indicate endorsement or other evaluation (e.g., through a browser control or user interface element presented with the associated content). Such relationships to information from oneself or others may be captured in a user's social graph.

Affinity between entities of a social graph may be represented by the above-noted edges in the user' social graph. In this context, affinity may identify the closeness of a party to a user. For example, a contact of a contact who has five common middle contacts with the user has more of an affinity with the user (e.g., is considered closer to the user) than a contact of a contact who has only one common middle contact. Factors in determining affinity may include, e.g.: how a contact is connected to the user (e.g., a source of a connection), which social networking site the contact is a member of, whether contact or contact of contact, and how many paths to get to the contact of a contact (e.g., common middle contacts). Edges may be weighted, either in a database containing the social graph or elsewhere, to reflect a level of affinity between connections (e.g., parties) in the social graph.

Affinity between parties may be content specific. For example, social graph data may identify specific types of content associated with an edge between parties and specific affinities for that content. For example, the social graph data may specify that, between two connected parties, the first party has a first level of affinity for the second party's videos and a second, different level of affinity for the second party's written work. Similarly, the social graph may specify that the second party has a third, different level of affinity for the first party's blogs. The same is true for content subject matter. For example, the social graph data may specify that, between two connected parties, the first party has a first level of affinity for the second party's content about safaris and a second, different level of affinity for the second party's content about Tanzania.

Affinity may also be based on the user's interactions with members of the social graph (e.g., the frequency of interaction, the type of interaction, and so forth). For example, a user that frequently selects (e.g., clicks on) posts by a particular contact may be considered to be closer to that contact than to other contacts where they select (e.g., click on) respective posts less frequently. Likewise, if a user frequently “mouses-over” content by an author (e.g., a search result link), but does not select that content, the degree of affinity may be less than if the link were selected. Similarly, an amount of time viewing content may be an indicator that one party likes content from another party. The amount of time viewing particular content may be an indication that one party likes that particular type of content from the other party, as opposed to other types of content from the other party.

In other examples, affinity may be defined by indirect interaction between users. For example, if two users interact with the same content regularly or frequently, those two users may be considered to have an affinity with one other. In still other examples, if two users interact with the same people regularly or frequently, those two users may be considered to have an affinity with one other.

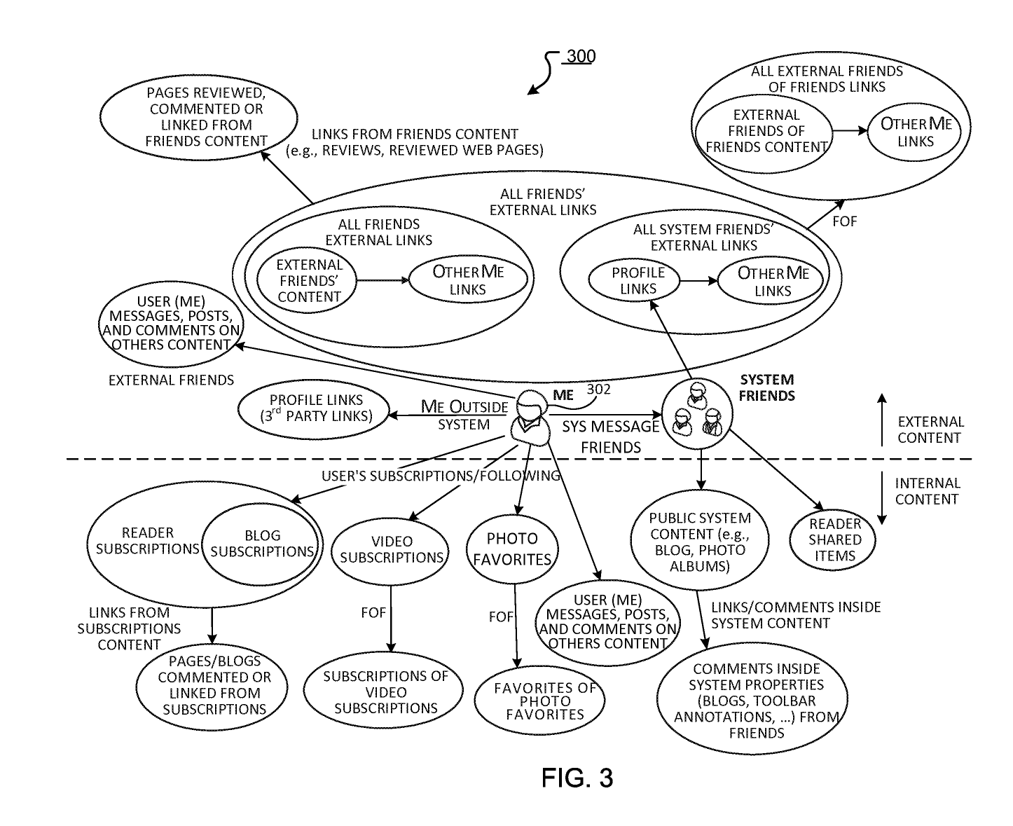

FIG. 3 is a conceptual view of an example social graph 300. Among other things, FIG. 3 shows sources of information for a social graph. In this example, the user's social graph is a collection of connections (e.g., users, resources/content, etc.) identified as having a relationship to the user 302 (“ME”) within some degree of separation. The user's social graph may include parties and particular content at different degrees of separation. For example, the social graph of a user may include contacts, contacts of contacts (e.g., as defined by a user, social graphing site, or other metric), the user's social circle, people followed by the user (e.g., subscribed blogs, feeds, or Web sites), co-workers, and other specifically identified content of interest to the user (e.g., particular Web sites).

FIG. 3 shows that it is possible to extend the user's social graph to people and content both within a single network and across one or more external networks. For example, the user may have a profile or contacts list that includes a set of identified contacts, a set of links to external resources (e.g., Web pages), and subscriptions to content of a system (e.g., a system that provides various content and applications including electronic messages, chat, video, photo albums, feeds, or blogs). Likewise, blogs that include links to a user's contacts may be part of the user's social graph. These groups may be connected to other users or resources at another degree of separation from the user. For example, contacts of the user may have their own profile that includes connections to resources as well as contacts of the respective contacts. In another example, a user may be connected to a social network account. That social network account may reference an article in a newspaper. A social connection, therefore, may be established between the user and the author of the article.

In some implementations, the connections to a user within a specified number of degrees of separation may be considered the bounds of the social graph of a user. Membership and degree of separation in the social graph may be based on other factors, including a frequency of interaction. For example, a frequency of interaction may be by the user (e.g., how often the user visits a particular social networking site) or it may be a type of interaction (e.g., endorsing, selecting, or not selecting items associated with contacts). As interactions change, the relationship of a particular contact in the social graph may also dynamically change. Thus, the social graph may be dynamic rather than static.

Social signals may be layered over the social graph (e.g., using weighted edges or other weights between connections in the social graph). These signals, for example, frequency of interaction or type of interaction between the user and a particular connection, may be used to weight particular connections in the social graph or social graphs without modifying the actual social graph connections. These weights may change as the interaction with the user changes.

Social graphs may be stored using suitable data structures (e.g., list or matrix type data structures). Information describing an aspect of a stored social graph may be considered relationship data. For example, relationship data may include information describing how particular members of a user's social graph are connected to a user (e.g., through what social path is a particular entity connected to the user). Relationship data may also include information describing social signals incorporated in the user's social graph. In some implementations, relationship data may be stored in a relationship lookup table (e.g., a hash table). Suitable keys for locating values (e.g., relationship data) within the lookup table may include information describing the identities of both a user and a member of the user's social graph. For example, a suitable key for locating relationship data within the lookup table may be (User X, User Y), where User Y is a member of User X's social graph.

Social graph information, including that described above, may be indexed for use in information retrieval. The social graph information may be part of a search index database in the indexed cache 214 of FIG. 2. Accordingly, the search index may be searched to identify relevant search results that are dependent upon social signals, e.g., that are associated with one or more aspects of a user's social graph, examples of which are provided above. For example, a search system may receive a query and identify, e.g., general search results and user-generated content. The user-generated content may include, e.g., search results based on the indexed social graph information (e.g., content from electronic messages, posts, blogs, chats, etc. of members of the searcher's social graph). The indexed social graph information may be updated intermittently or periodically, for example, to include recently added information associated with the user's social graph. The indexed social graph information may also be updated, e.g., on an on-going basis to reflect relationships determined in accordance with the processes described herein.

It is noted that a user may prevent addition of members to the user's social graph, e.g., using an option or by keeping contacts out of particular groups used to generate the social graph. In some implementations, privacy features provide a user with option(s) to allow or to prevent being included (or removed the user if already included) as a member of another's social graph. Thus, users may have control over what personal information or connection information, if existing, is included in their social graphs and, consequently, that may be included in search results pages.

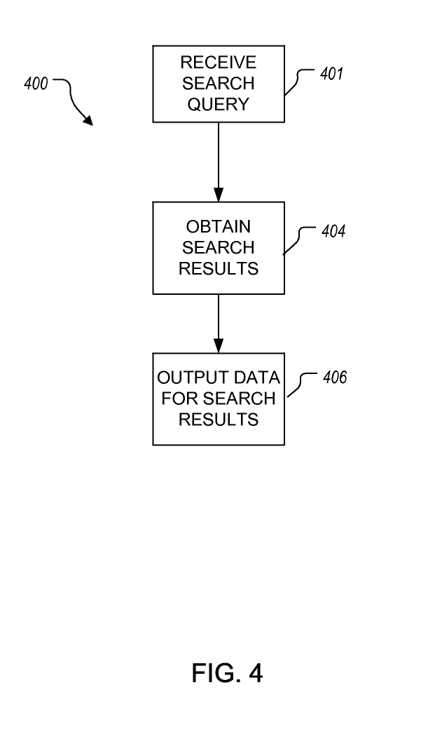

FIG. 4 is a flow diagram of an example process 400 for retrieving and presenting search results, including social graph information. For illustration, process 400 will be described with respect to a search system 212.

Process 400 receives (402) a search query. For example, search system 212 receives (402) a search query from a user 124. The user may input the search query into a search interface of a particular system. The search query may include, e.g., one or more query terms, images, audio, video, or other content, and may be general or directed to particular types of resources (e.g., a Web search or an image search).

User 124 may submit the search query from a client device (e.g., computing device 104). After the user submits the search query, the search query is transmitted through a network (e.g., network 111) to search system 212. Process 400 obtains (404) search results that are responsive to the search query. For example, search system 212 obtains (404) search results, including user-generated content. The search results may include content generated by one or more members of the user's social graph.

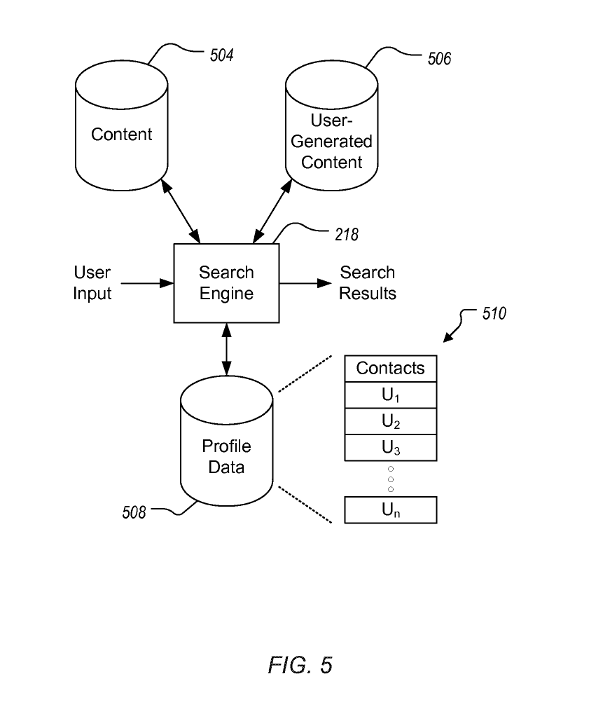

In this regard, FIG. 5 depicts example components of search system 212 (of FIG. 2) that may be used to retrieve search results including user-generated content associated with one or more members of the user's social graph. The example components include search engine 218 and indexes (which may be in indexed cache 214) including a content data source 504, a user-generated content data source 506 and a profile data source 508. Search engine 218 receives user input, processes the user input based on data provided from the data sources 504, 506, 508 and generates search results. The user input may be provided using a computing device (e.g., a client computing device) and the search results may be provided to the computing device for display to the user.

In some examples, the user input may also include user log-in information (e.g., username and password) that may be used to log the user into a search service provided by search engine 218. Search engine 218 may identify a user profile based on the user input and may retrieve profile data corresponding to the user from profile data source 508. In some examples, the user profile data may include a contact index 510. Contact index 510 may be used to identify members of the user's social graph. For example, the user's social graph may include user's U1, . . . Un.

The user input may include a search query that is received by search engine 218. In response to receiving the search query, search engine 218 may process data provided by content data source 504 and user-generated data source 506 to generate search results. In some examples, in response to receiving the search query, search engine 218 may retrieve contact index 510 corresponding to the user that provided the search query (e.g., based on the user's log-in information). Search engine 218 may access user-generated data source 506 to retrieve user-generated content that may be relevant to the search results and that the search user is allowed to access. In some examples, the user-generated content may include, but is not limited to, one or more of electronic messages, chats, posts to social networking services, blog posts, and/or microblog posts. The user-generated content may be content that is generated by members of the searching user's social graph or content that is generated by the searching user themselves. Search engine 218 may receive the user-generated content and data associated with the user-generated content, and make a determination as to whether particular user-generated content is to be output as search results. As noted above, the determination may be made, at least in part based on relevance scores of the content to the search query, which may be influenced by the searcher's social connection to the content (e.g., to an author of the content).

Process 400 outputs (406) data corresponding to the search results. For example, search system 212 outputs (406) data corresponding one or more of search results, including, e.g., user-generated content, to computing device 104. For example, the search system may output data corresponding to search results that includes content generated by one or more members of the user's social graph and/or by the searching user himself or herself. In some implementations, search engine 218 may transmit retrieved search results through network 111 to the computing device 104 for presentation to the user, for example, as a search results Web page to be displayed in a Web browser running on computing device 104. In some implementations, search system 212 presents responsive search results associated with the user's social graph together in a cluster, separate from general search results. In some implementations, the system presents search results associated with the user's social graph intermixed with retrieved general search results.

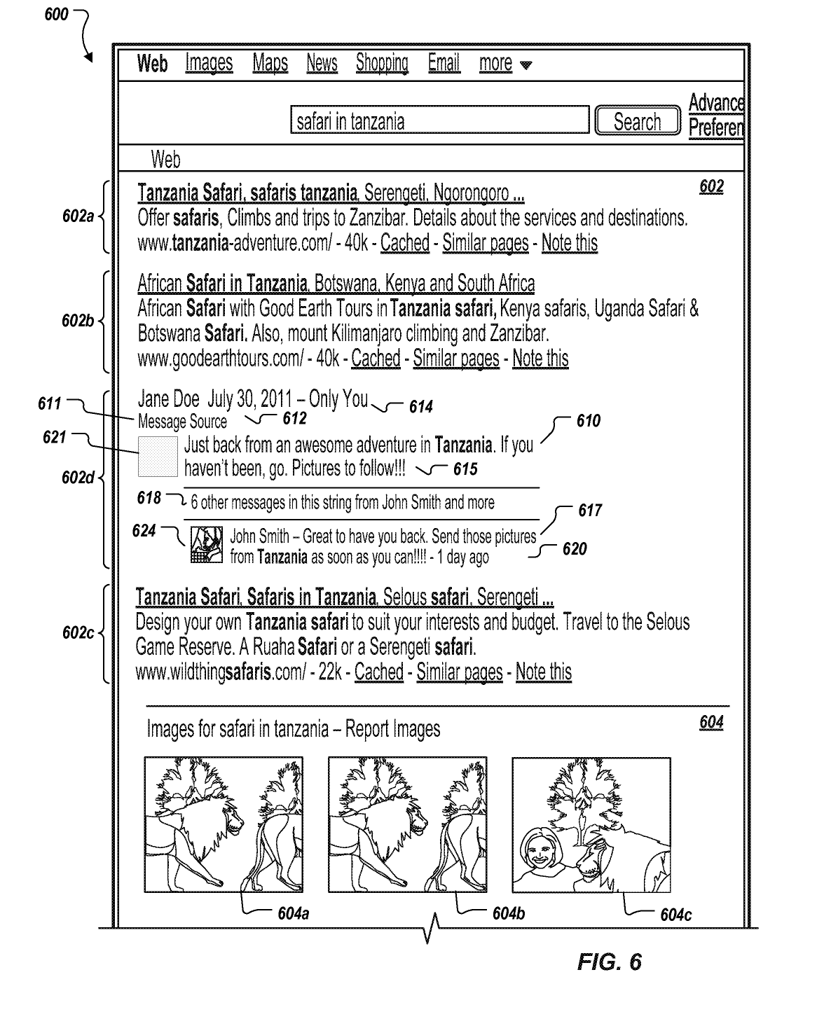

FIGS. 6 to 17 shows example of Web pages containing user-generated search results. The data output by the search engine is used by a Web browser to generate search results having, e.g., formats like those shown in FIGS. 6 to 17.

FIG. 6 is an example Web page 600 that includes, among the search results, content generated by members of the searcher's social graph. Search results page 600 displays example search results responsive to the example query “safari in Tanzania”, with the query terms highlighted. In this example, the displayed search results include Web search results 602 and image search results 604. Web search results 602 include search results 602a, 602b, 602c, 602d.

Search results 602a, 602b, 602c are associated with resources (e.g., Web pages) that are publicly accessible, e.g., on the Internet. These search results may have relevance scores that are determined without regard to the user's social connections. Search result 602d includes user-generated content that is deemed to be relevant to the search query possibly, at least in part, due to a social connection to the searcher. In the depicted example, search result 602d includes access-controlled content, in particular, an electronic message that was transmitted over a messaging service. For example, the author “Jane Doe”, who is on the searcher's social graph, generated electronic message (or simply, “message”) 610 and sent the electronic message to others. Although an electronic message is depicted in FIG. 6, other appropriate user-generated content may be displayed, e.g., posts to a social networking site, microblogs, and so forth. In the cases of posts to a social networking site, the distribution may include a public distribution, such that a user, whether a contact of the author user, is able to access the post.

In this example, search result 602d identifies a source 611 of the electronic message. The source may include, e.g., the identity of the messaging service, along with, e.g., the storage location of the electronic message in the electronic message service. Search result 602d also may include the date 612 of the electronic message, a subject 614 associated with the electronic message, and text excerpt 615 from the electronic message. The subject may be gleaned from a tag line associated with the message or, e.g., from content in the message itself (e.g., the first line of the electronic message or elsewhere in the electronic message).

Search result 612d may also identify the number and author(s) 618 of related electronic messages. Content (e.g., text) 617 from a related electronic message 620 that contains content (here, “Tanzania”) from the original search query may be also be shown, along with the identity of the corresponding author. In cases where an image of the author is available (e.g., if the author is on the same social network as the user, and the search system has authorized access to that author's profile), a thumbnail image of the author may be presented alongside of the electronic message or elsewhere on the search results page. In the example of FIG. 6, a picture of the author of electronic message 610 (“Jane Doe”) is not available; accordingly, a blank box 621 is presented. In some examples, as noted below, the blank box may be omitted altogether. In the example of FIG. 6, a picture of the author of electronic message 620 (“John Smith”) is available; accordingly, a thumbnail version 624 of that picture is displayed next to content from the electronic message from John Smith.

Image results 604 include search results associated with images that are publicly available and images that are associated with a social graph of the user. For example, the image results may include images 604a, 604b, 604c. In the depicted example, images 604a, 604b may include publicly available images and image 604c includes an image that is posted by a member of the searching user's social graph. For example, image 604c may be an image posted by the user “Jane Doe,” who authored the electronic message provided as search result 602d. Alternatively, image 604c may have been part of (e.g., embedded in, attached to, etc.) that electronic message.

In this regard, in some examples, if the user-generated content includes a single image and text, the user-generated content may be displayed as a Web search result (e.g., in the Web search results 602 of FIG. 6). In some examples, if the user-generated content includes one or more images without text, the image may be displayed within the image search results. In the example of FIG. 6, image 604c may be an image that was provided in a post that was distributed using a social networking service or that was sent in an electronic message and that did not include text. Consequently, image 604c is displayed in the image search results 604 instead of the underlying content being displayed as a search result in and of itself. In some examples, if the user-generated content includes a plurality of images with text, the user-generated content may be displayed as a Web search result (e.g., in the Web search results 602 of FIG. 6) and the images may be displayed as image search results (e.g., in the image search results 604 of FIG. 6).

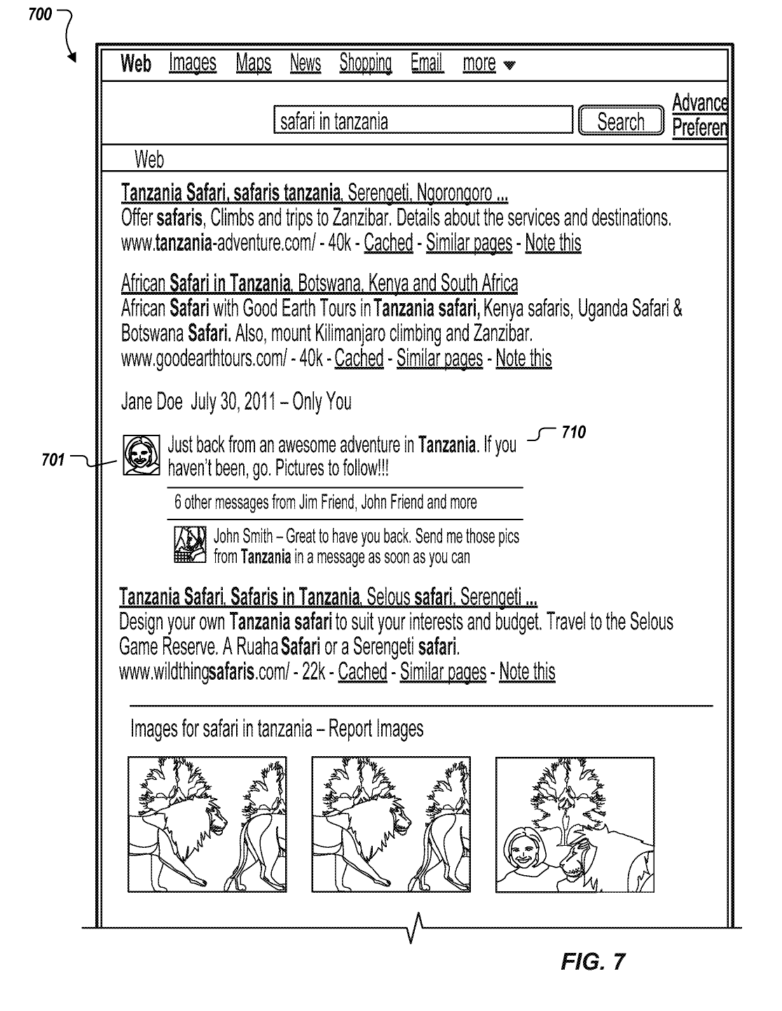

FIG. 7 shows an example search results Web page 700 that is similar to Web page 600 of FIG. 6, and that includes a picture 701 of the author of electronic message 710, Jane Doe.

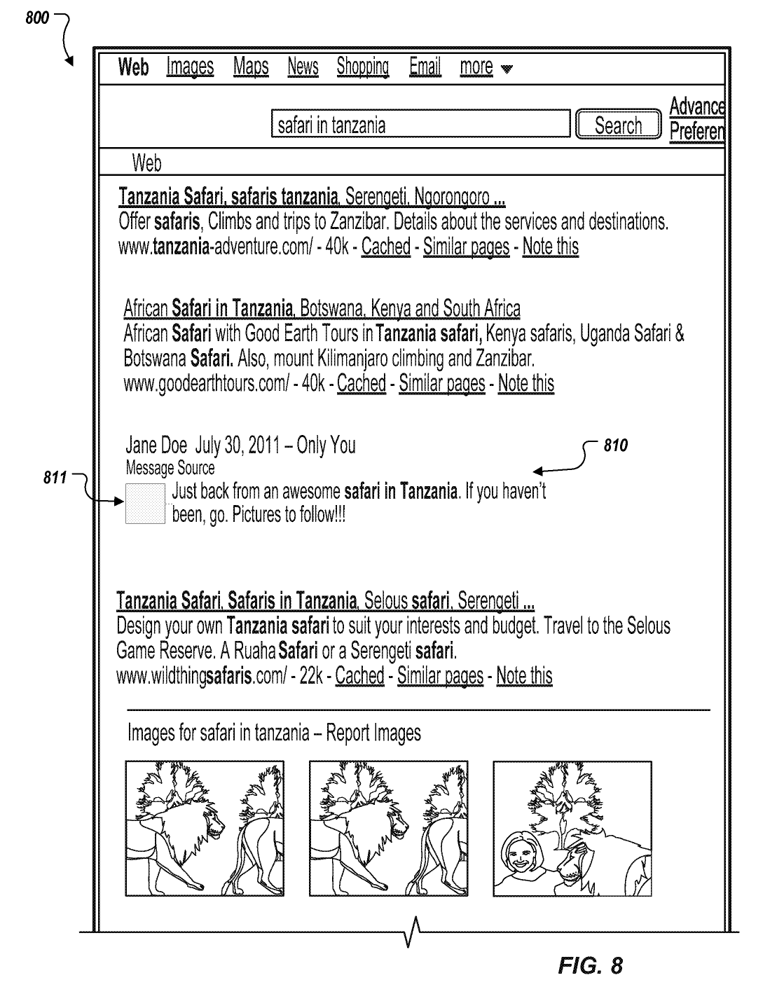

FIG. 8 shows an example search results Web page 800 that is similar to Web page 600 of FIG. 6, but that includes neither a picture of the author of electronic message 810, namely Jane Doe, nor related electronic messages. For example, the system may not provide related electronic messages for display or there may be no related electronic messages in the search index. In this case, a blank box 811 is included on Web page 800.

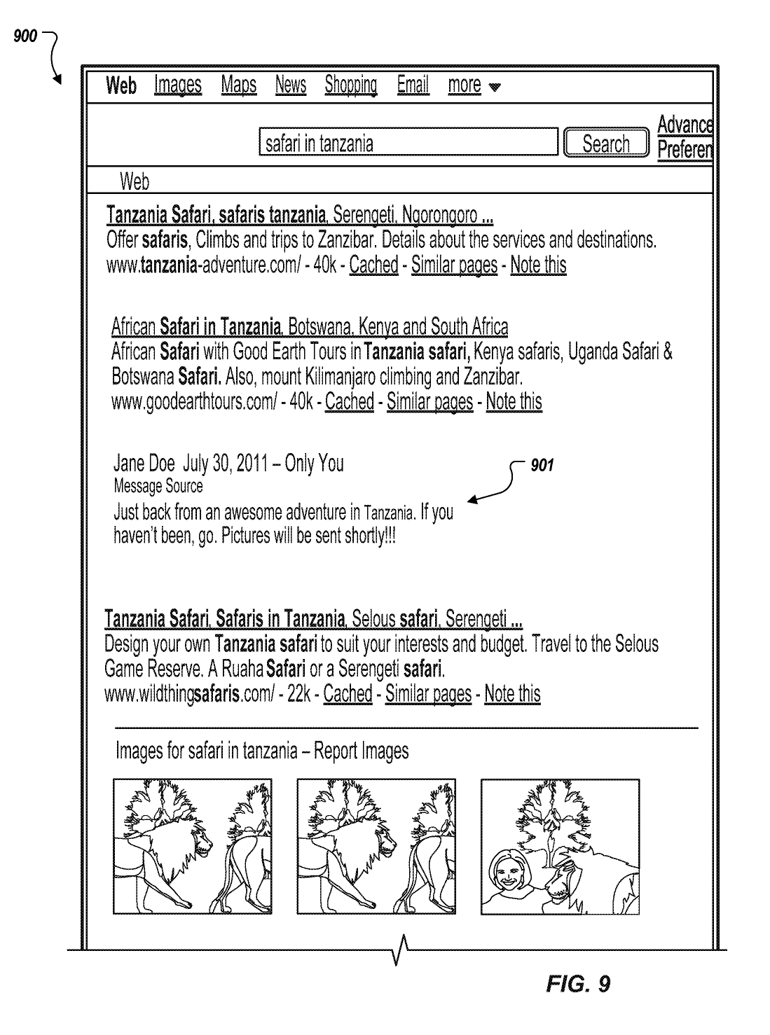

FIG. 9 shows an example search results Web page 900 that is similar to Web page 600 of FIG. 9, but that includes neither a picture of the author of electronic message 901, nor a blank box.

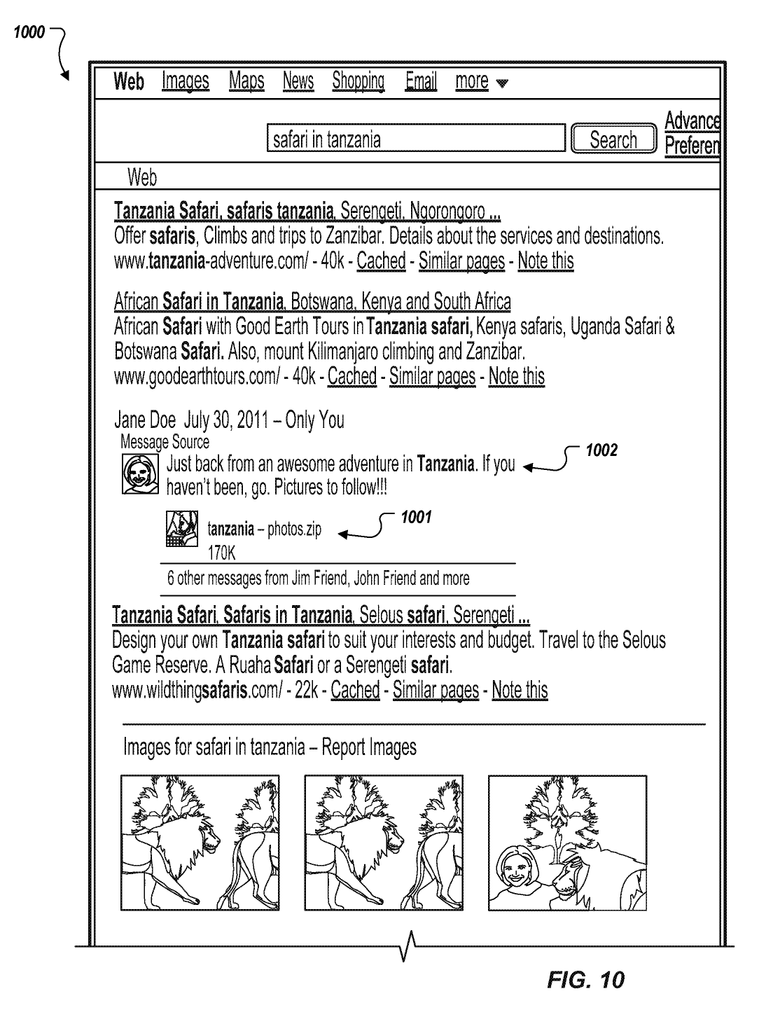

FIG. 10 shows an example search results Web page 1000 that is similar to Web page 600 of FIG. 6, but that includes a link 1001 to content from electronic message 1002. In this example, the content includes compressed images. The content may be, for example, an attachment from the electronic message or it may have been embedded in the electronic message. The search index may correlate the message and the content, thereby allowing the search engine to identify a relationship between the two, and to generate the depicted search results. Although compressed images are depicted, other appropriate content may be included in the search results. For example, video, audio, text, documents, or the like may be included in addition to, or instead of, the compressed images. Furthermore, such content need not be compressed.

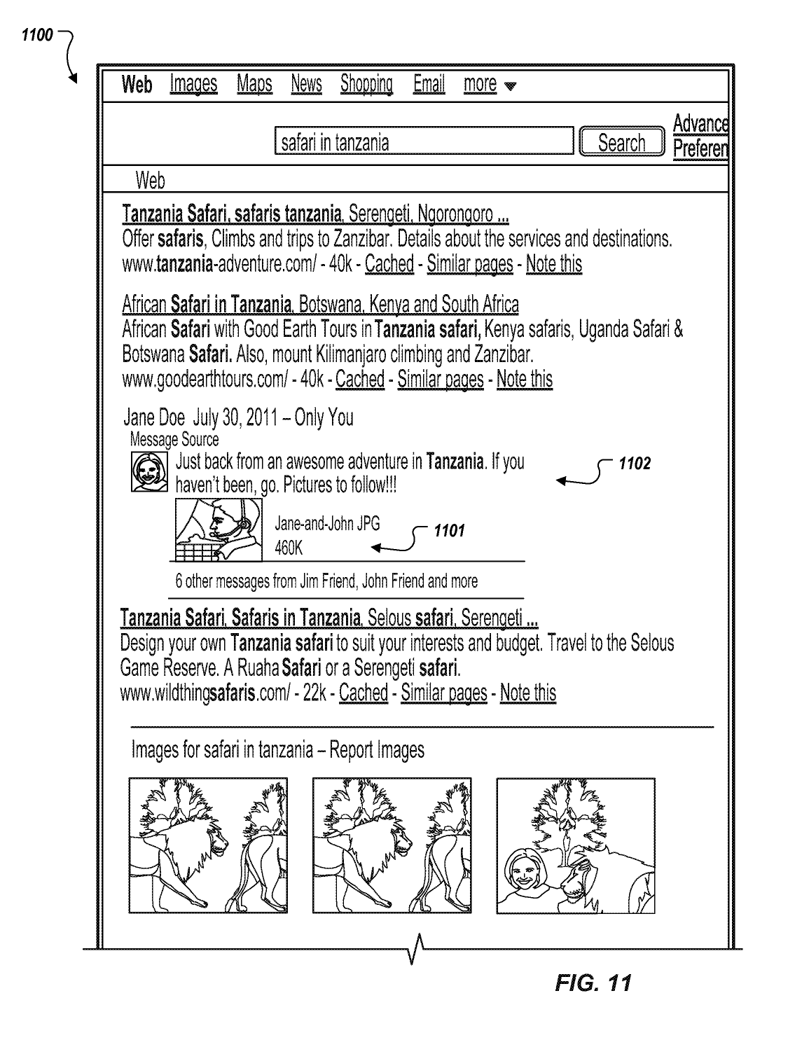

FIG. 11 shows an example search results Web page 1100 that is similar to Web page 600 of FIG. 6, but that includes content 1101 from electronic message 1102 displayed near (in this example, underneath) text from the electronic message. The content, in this example, is an image. As above, the content may be, for example, an attachment to the electronic message or it may have been embedded in the original electronic message. Although an image is depicted, other appropriate content may be included in the search results. For example, video, text, documents, or the like may be included in addition to, or instead of, the image.

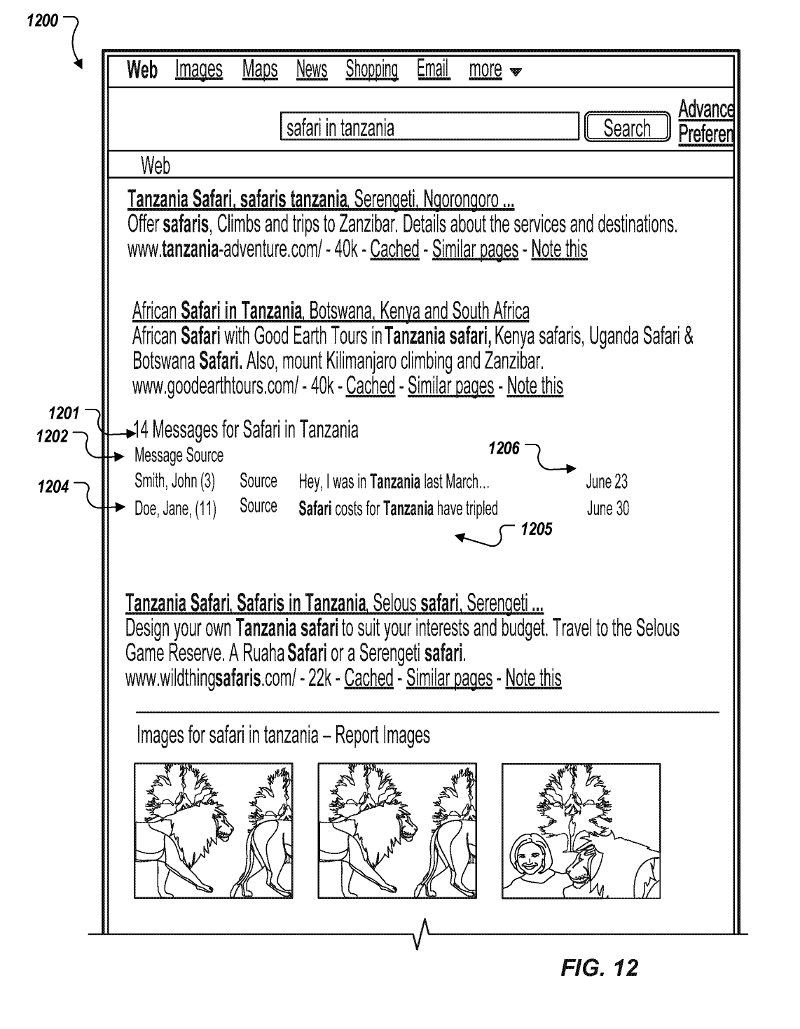

FIG. 12 shows an example of an alternative search results Web page 1200 showing content in response to the input search query “safari in tanzania”. In the example of FIG. 12, the number 1201 of electronic messages identified in response to the search query is presented. The source 1202 of the electronic message may also be included, as was the case above. Information about/from the electronic message is displayed in a list 1204. In this example, the list includes an identity of the electronic message author (e.g., “Smith, John” and “Doe, Jane”), along with the number of possibly relevant electronic messages by each author. In the example of FIG. 12, John Smith has three related electronic messages and Jane Doe has eleven related electronic messages. The related electronic messages may include the original query terms or they may relate in some way to the original electronic message (e.g., the related electronic messages may be responsive to the original electronic message or part of the same electronic message string). Content 1205 from one or more of the electronic messages may be presented, with the query terms highlighted. The content may be, e.g., the content deemed by the search engine to be most relevant to the query or it may be content from the first electronic message in an electronic message string. Dates 1206 associated with the electronic messages also may be displayed. The dates may be, for example, the sent date of the first or last electronic message by the corresponding author.

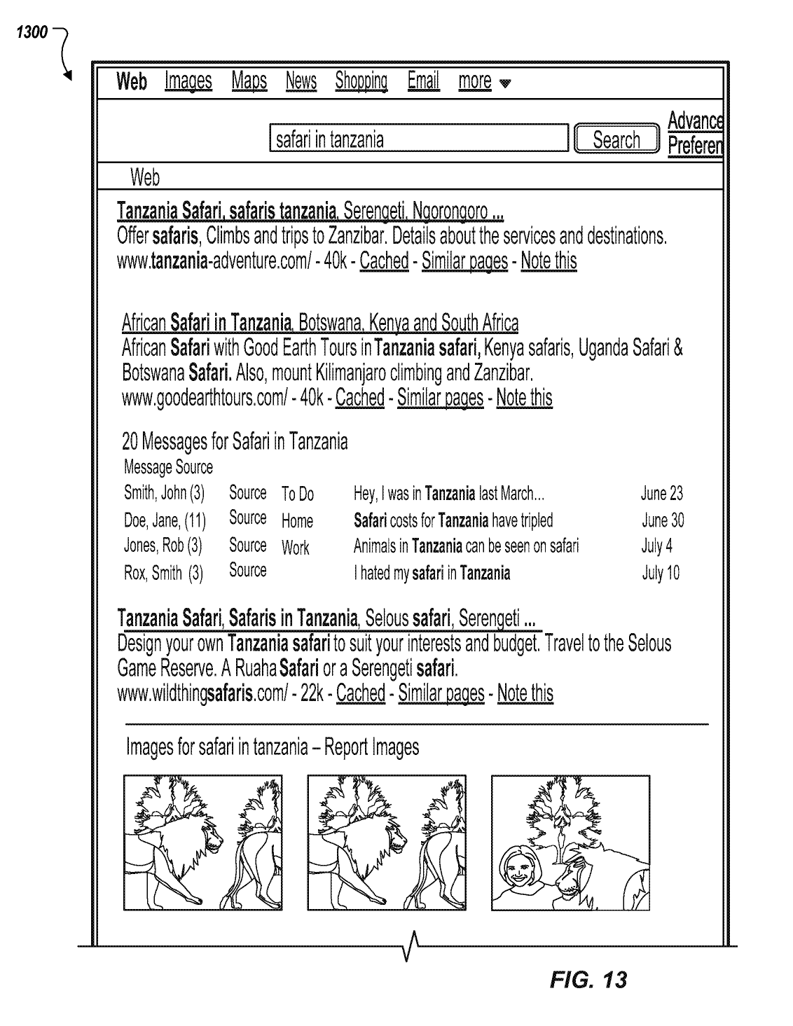

FIG. 13 shows an example search results Web page 1300 that is similar to Web page 1200 of FIG. 12, but that also includes, for corresponding electronic messages, other information about the source of the electronic message. For example, for electronic messages associated with Rob Jones, the source may be his work account (versus his home account or others).

In some implementations, if a user has given a search engine permission to access an account, e.g., an electronic messaging account, it is possible for the search engine to index messages or other content in the account and retrieve messages or other content that match a search query. However, sometimes the best answer to a user's search query is buried deep in a poorly-formatted email. It is possible to extract data relevant to the user's search task from a message or other content and to display that to the user in a format that allows the user to quickly obtain the desired information without having to read the entire email message. Because the data extracted from the message or other content is relevant to the user's task, it can be much more prominently displayed in the search results than other messages or content that is not as relevant.

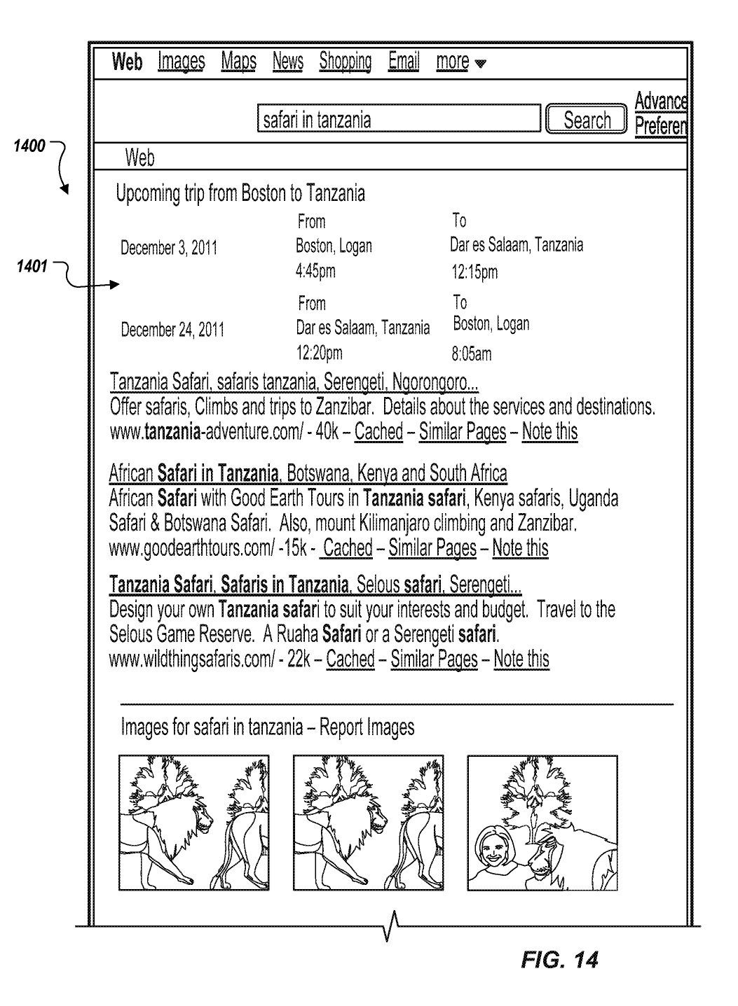

FIG. 14 shows an example of content 1401 from an electronic message that relates to a safari trip to Tanzania. In this example, the content includes a flight itinerary for the trip. The flight itinerary may have been sent, e.g., in an electronic message from a travel agent to the searcher. As shown in FIG. 14, content 1401 is displayed at the top of the search results page (e.g., prominently), thereby signifying its potential relevance. Content from sources other than electronic messages may be displayed. Other examples of content that may be displayed prominently include, but are not limited to, e.g., order receipts, order summaries, images of products ordered, maps to locations that are the subject of user-generated content, and so forth.

As noted, in some implementations, a user may give a search engine permission to access an account containing the user's confidential or non-public user-generated content. For example, the user may give the search engine permission to access electronic messaging account, a calendar, a cloud drive, and so forth. In these implementations, the search engine may index messages or other content in the account, may retrieve messages or other content that match a search query, and may present these messages, or portions thereof, in search results.

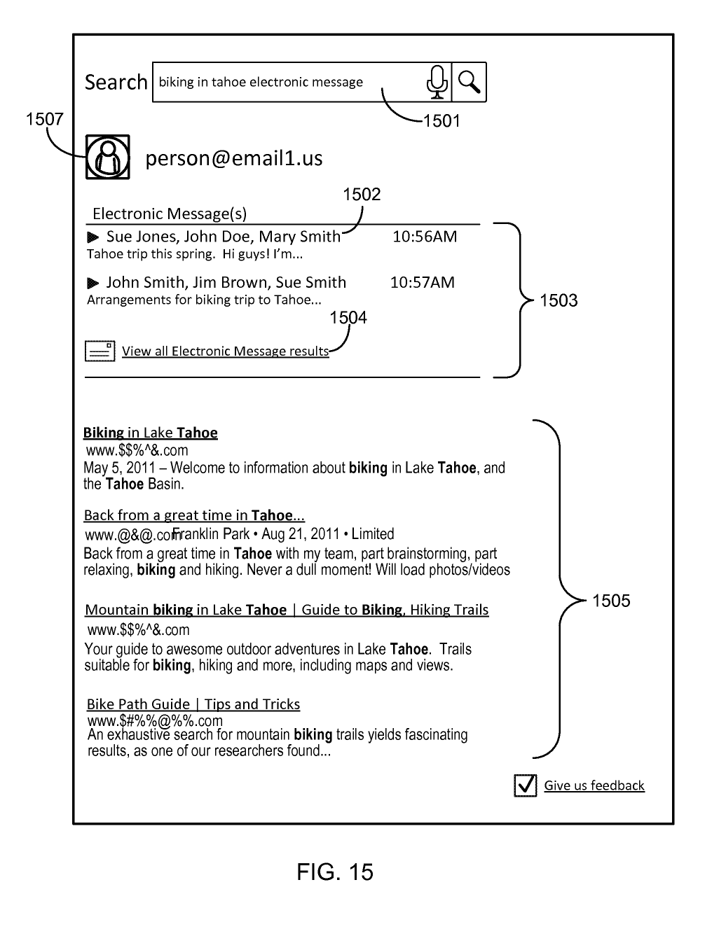

In the example implementation of FIG. 15, the user has given the search engine access to, and thus the ability to index and search, the user's online electronic messaging account. Accordingly, in response to a search query 1501, the search engine also searches the user's account for content relevant to search query 1501. In this example, there are some electronic messages 1502 are deemed relevant to the search query. In this example, excerpts from those electronic messages are displayed at a predefined area 1503 of search results. Area 1503 may be at the top of a first page of search results. The electronic messages are determined to be relevant based on their determined relevance scores, and are ranked for display according to their determined ranking scores. The electronic messages may be messages generated by, received by, or sent by, the user.

Because there is a limited amount of space at the top of the first page of search results, only excerpts from the first few ranked and relevant electronic messages are displayed in some implementations. For example, excerpts from the first one, two, three, four, five, ten, and so forth electronic messages may be displayed. In some implementations, the search results page may include an option 1504 to display more, or all, relevant electronic messages. In some implementations, a scroll bar (not shown) may be presented to the left or to the right of the displayed electronic messages, which allows the user to scroll through and to select an electronic message. In this regard, electronic messages may be selected and viewed in the same way as search results 1505 from non-public sources (e.g., by pointing and clicking, touching, etc.). In some implementations, a user may be prompted to provide a password before access to the full content of an electronic message is provided. In other implementations, no password need be provided to allow the user to access the full content of any displayed electronic message.

In some implementations, a selected electronic message may be opened inside the user's account, rather than in the search results page of FIG. 15. For example, each message may contain a hyperlink to the user's account which, if selected, opens a new page containing the user's account and the entire content of the message. In some implementations, the user may be prompted for a password at this time. In other implementations, the user may sign-in to a related account prior to conducting a search, thereby allowing message content to be displayed without requiring further input (e.g., of a password, user ID or the like).

In some implementations, the portion of the search page containing electronic messages is formatted to resemble the format in which electronic messages are presented in the user's account. For example, each electronic message may contain a subject line, a date, and so forth. In some implementations, if available and appropriate permission has been obtained, a picture 1507, or other user-selected or assigned icon, that is associated with the user's electronic messaging account may be displayed on the search results page. This picture may indicate to the user that the search results contained in that portion of the page are from their account, and are not obtained from public sources.

In some implementations, search results containing electronic messages are displayed in area 1503 only if the input search query specifically requests electronic messaging content. For example, if the search query is “biking in Tahoe electronic message”, the words “electronic message” in the search query indicate to the search engine that the user would like to include electronic messages in their search results. This information indicates to the search engine to generate a search results page like that shown in FIG. 15, e.g., one that includes an area 1503 with links to relevant and ranked electronic messages.

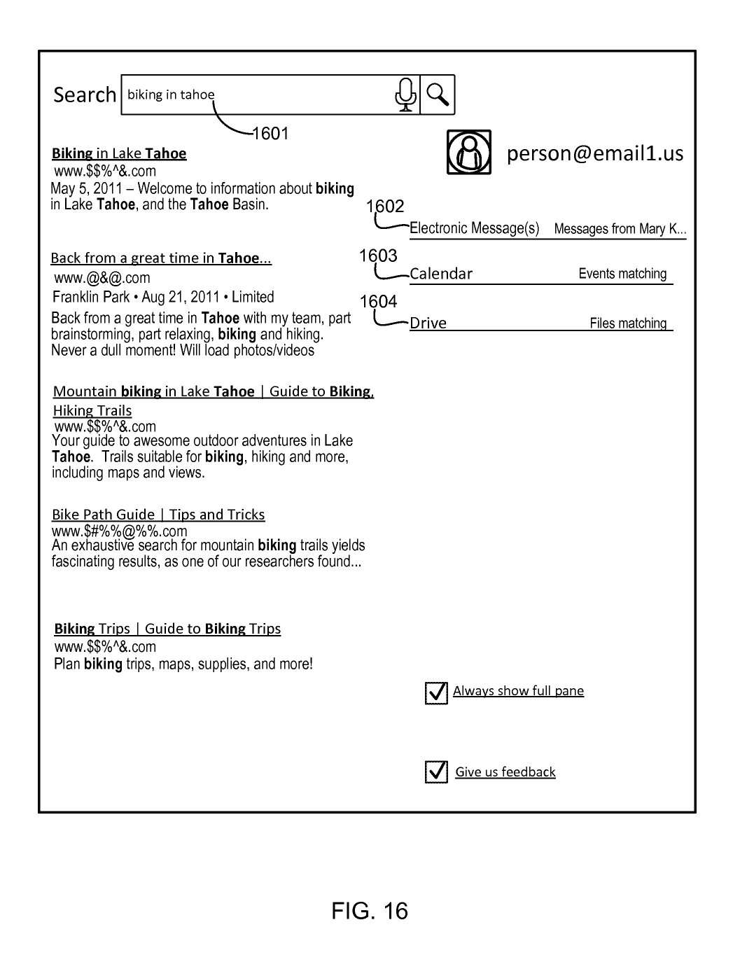

If an input search query does not specifically request electronic messaging content (e.g., if the query were to read “biking in Tahoe” only), the search engine may still make confidential or non-public search content available to the user (where appropriate permission has been obtained). For example, referring to FIG. 16, the search query 1601 is “biking in Tahoe”, and does not include any reference to electronic messages or other user-generated content. In this case, the search engine may identify relevant user-generated content in the manner described above, and provide the user with an option 1602 to view the search results. In some implementations, option 1602 identifies the type of user-generated content that it contains. For example, option 1602 specifies electronic messages. In some implementations, additional options may be available to provide relevant content, e.g., from a user's online calendar 1603, cloud drive 1604, and so forth.

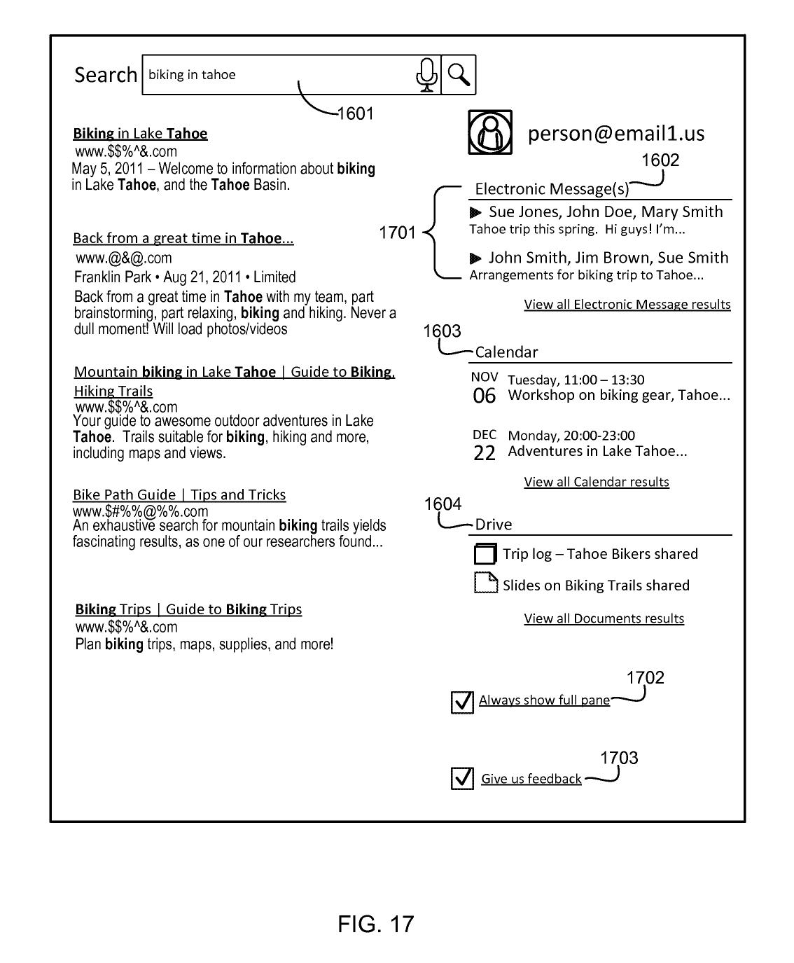

In some implementations, selecting a corresponding option displays the corresponding content. For example, selecting option 1602 may cause the display of portions of electronic messages in a manner similar to the way in which those portions were displayed in FIG. 15. For example, referring also to FIG. 17, selecting option 1602 causes portions of electronic messages to be displayed in area 1701. The display may be similar in look and function to that provided in area 1503 of FIG. 15. For example, selecting a displayed electronic message may direct the user to their messaging account to view the entire contents of that message. The same may be true for other types of content, such as calendar content and cloud drive documents, examples of which are also shown in FIG. 17.

As noted above, initially, the search engine may identify relevant user-generated content and provide the user with an option 1602 to view corresponding search results. Although not shown with the implementation of FIG. 15, such an option, rather than actual search results, may first be displayed, and may be selected to view electronic messages 1502. A reason for displaying an option to view content, rather than displaying the actual content, is privacy. In this regard, a user may not wish to display their confidential or non-public user-generated content on a search results page, particularly if that page may be viewed by others. Accordingly, a link to such content may be displayed, as shown in FIG. 16. In some implementations, the content may be displayed in a collapsible drop-box.

In some implementations, the search engine may provide a selectable option 1702. In this implementation, option 1702 is a checkbox; however, other types of options may be provided. In some implementations, a user may edit their settings or profile to perform the same function as the selectable option. In some implementations, this selectable option may indicate, to the search engine, to always show the full panel, meaning a list, or a portion thereof, of content items in uncollapsed form (as shown in the implementation of FIG. 15). In some implementations, there may be an option 1702 for each type of content, e.g., electronic messages, calendar items, drive documents, and so forth. In some implementations, a single option 1702 may affect all content items.

In some implementations, the search engine may provide an option 1703 to provide the search engine with feedback on use of the confidential or non-public user-generated content. For example, with the user's permission, as indicated by a check in the box for option 1703, the search engine may collect information, such as whether and how often the user interacts with the confidential or non-public user-generated content. By simply disabling (e.g., unchecking) this option, the user may prevent collection of such information.

The processes described herein and variations thereof (referred to as “the processes”) may contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph. In this regard, as noted elsewhere herein, privacy features provide a user with an option to allow or to prevent, respectively, their private or proprietary content from being included in search results of the type described herein.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to a signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be a form of sensory feedback (e.g., visual feedback, auditory feedback, or tactile feedback); and input from the user may be received in a form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or a combination of such back end, middleware, or front end components. The components of the system may be interconnected by a form or medium of digital data communication (e.g., a communication network). Examples of communication networks include a local area network (“LAN”), a wide area network (“WAN”), and the Internet.

The computing system may include clients and servers. A client and server are generally remote from one other and typically interact through a communication network. The relationship of client and server arises by virtue of computer programs running on the respective computers and having a client-server relationship to one other.

Content generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Although implementations are discussed primarily in the context of digital content generated and distributed in the form of electronic messages, implementations are applicable to other content types including, for example, chat content, social networking posts, content posted to sharing services (e.g., photo sharing services), content posted to a blogging services, and so forth.

Although implementations are discussed primarily in the context of presenting user-generated content from members of the searcher's social graph, user-generated content from parties who are not members of the searcher's social graph may also be presented. For example, if a user is searching for a particular topic, if available and appropriate permissions have been obtained, user-generated content from experts on that topic may be presented, even if those experts are not part of the searcher's social graph.

In some implementations, the engines described herein may be separated, combined or incorporated into a single or combined engine. The engines depicted in the figures are not intended to limit the systems described here to the software architectures shown in the figures.

Elements of different implementations described herein may be combined to form other implementations not specifically set forth above. Elements may be left out of the processes, computer programs, Web pages, etc. described herein without adversely affecting their operation. In addition, the logic flows depicted in the figures do not require the particular order shown, or sequential order, to achieve desirable results. Various separate elements may be combined into one or more individual elements to perform the functions described herein.

The features described herein may be combined in a single system, or used separately in one or more systems.

Other implementations not specifically described herein are also within the scope of the following claims.

What is claimed is:

1. A method performed by one or more processing devices, comprising:
receiving a search query from a computing device of a first user;
identifying one or more social connections between the first user and one or more other users;
identifying one or more first search results that correspond to digital content stored in one or more computer-readable storage media, the one or more first search results i) responsive to the search query based on a relevance score of the one or more first search results to the search query and ii) correspond to first content that is created by a first subset of the other users that are socially connected to the first user;
identifying one or more second search results that correspond to digital content stored in one or more computer-readable storage media, the one or more second search results i) responsive to the search query based on a relevance score of the one or more second search results to the search query and ii) correspond to second content that is interacted by a second subset of the other users that are socially connected to the first user, the second subset of the other users are non-creators of the second content, wherein, for each item of second content, the relevance score is based on a non-existence of a social connection between the first user and the other user of the second subset of the other users that interacted with the second content item;
obtaining control information associated with each of the one or more first and second search results, and based on the control information, identifying a first subset of the one or more first and second search results that may be included in search results;
identifying one or more third search results that correspond to digital content stored in one or more computer-readable storage media, the one or more third search results including search results other than the user-created digital content and the user-interacted digital content; and
transmitting data corresponding to i) the first subset of the one or more first and second search results and ii) the one or more third search results to the computing device for generating a display of the search results in accordance with the data.

2. (canceled)

3. The method of claim 1, wherein identifying the one or more first search results comprises:
searching indexed content corresponding to the first subset of the one or more other users to identify the one or more first search results.

4. The method of claim 1 further comprising:
identifying third content that is associated with the first content; and
including the third content in the one or more first search results;
wherein the data is for displaying the third content in association with the first content.

5. The method of claim 4, wherein the third content is part of the first content.

6. The method of claim 4, wherein the third content is responsive to the first content or the first content is responsive to the third content.

7. The method of claim 1, wherein the one or more first search results comprise a type of content, and the user-created digital content contains the type of content,
wherein the data is for displaying the type of content from the user-created digital content among the type of content from the one or more first search results and apart from other types of content in the one or more first search results.

8. The method of claim 1, wherein the data corresponding to the first subset of the one or more first search results comprises an excerpt from the user-created digital content.

9. The method of claim 1, wherein the data corresponding to the first subset of the one or more first search results comprises a summary of information about the user-created digital content.

10. The method of claim 9, wherein the summary of information comprises at least one of: an identity of a social connection associated with user-created digital content, a number of instances of the user-created digital content, a number of instances of user-created digital content per social connection, a source of the user-created digital content, and an excerpt from the user-created digital content.

11. The method of claim 1, wherein the user-created digital content comprises a digital image, and wherein the method further comprises:
determining that the user-created digital content is independent of text associated with the digital image; and
determining that the digital image is to be displayed within an image search results portion of the search results in response to determining that the user-created digital content is independent of text associated with the digital image.

12. The method of claim 1, wherein the user-created digital content comprises at least one of: an electronic message, text from a chat session, a post to a social networking service, a digital image, video, audio, and a blog post.

13. (canceled)

14. (canceled)

15. The method of claim 1, further comprising:
determining whether the search query identifies a type of user-created digital content;
wherein display of the search results is based on whether the search query identifies a type of user-created digital content.

16. The method of claim 15, wherein, in a case that the search query identifies the type of user-created digital content, the data indicates to display search results containing user-created digital content at a top of a first page of search results.

17. The method of claim 15, wherein, in a case that the search query does not identify the type of user-created digital content, the data indicates to display an option to view search results containing user-created digital content proximate to the search results other than the user-created digital content.

18. The method of claim 15, wherein, in a case that the search query does not identify the type of user-created digital content, and the user has indicated to display at least some of the user-created digital content, the data indicates to display search results containing at least some of the user-created digital content proximate to the search results other than the user-created digital content.

19. One or more non-transitory machine-readable storage media storing instructions that are executable by one or more processing devices to perform operations comprising:
receiving a search query from a computing device of a first user;
identifying one or more social connections between the first user and one or more other users;
identifying one or more first search results that correspond to digital content stored in one or more computer-readable storage media, the one or more first search results i) responsive to the search query based on a relevance score of the one or more first search results to the search query and ii) correspond to first content that is created by a first subset of the other users that are socially connected to the first user;
identifying one or more second search results that correspond to digital content stored in one or more computer-readable storage media, the one or more second search results i) responsive to the search query based on a relevance score of the one or more second search results to the search query and ii) correspond to second content that is interacted by a second subset of the other users that are socially connected to the first user, the second subset of the other users are non-creators of the second content, wherein, for each item of second content, the relevance score is based on a non-existence of a social connection between the first user and the other user of the second subset of the other users that interacted with the second content item;
obtaining control information associated with each of the one or more first and second search results, and based on the control information, identifying a first subset of the one or more first and second search results that may be included in search results;
identifying one or more second third results that correspond to digital content stored in one or more computer-readable storage media, the one or more third search results including search results other than the user-created digital content and the user-interacted digital content; and
transmitting data corresponding to i) the first subset of the one or more first and second search results and ii) the one or more third search results to the computing device for generating a display of the search results in accordance with the data.

20. A system comprising:
one or more processing devices for executing instructions for a search engine, the instructions being executable to perform operations comprising:
receiving a search query from a computing device of a first user;
identifying one or more social connections between the first user and one or more other users;
identifying one or more first search results that correspond to digital content stored in one or more computer-readable storage media, the one or more first search results i) responsive to the search query based on a relevance score of the one or more first search results to the search query and ii) correspond to first content that is created by a first subset of the other users that are socially connected to the first user;
identifying one or more second search results that correspond to digital content stored in one or more computer-readable storage media, the one or more second search results i) responsive to the search query based on a relevance score of the one or more second search results to the search query and ii) correspond to second content that is interacted by a second subset of the other users that are socially connected to the user, the second subset of the other users are non-creators of the second content, wherein, for each item of second content, the relevance score is based on a non-existence of a social connection between the first user and the other user of the second subset of the other users that interacted with the second content item;
obtaining control information associated with each of the one or more first and second search results, and based on the control information, identifying a first subset of the one or more first and second search results that may be included in search results;
identifying one or more third search results that correspond to digital content stored in one or more computer-readable storage media, the one or more third search results including search results other than the user-created digital content and the user-interacted digital content; and
transmitting data corresponding to i) the first subset of the one or more first and second search results and ii) the one or more third search results to the computing device for generating a display of the search results in accordance with the data.
